(19) United States
(12) Patent Application Publication
(10) Pub. No.: US 2026/0303965 A1
(43) Pub. Date: Oct. 1, 2026

(54) GROOMING MODE IN A COMPUTING DEVICE

(71) Applicant: MOTOROLA MOBILITY LLC, WILMINGTON, DE (US)

(72) Inventors: AMIT KUMAR AGRAWAL, BANGALORE (IN); Srikanth Ramaraju, BANGALORE (IN); Renuka Prasad Herur Rajashekaraiah, BANGALORE (IN)

(21) Appl. No.: 19/094,956

(22) Filed: Mar. 30, 2025

(51) Int. Cl. H04N 23/667; G06V 40/16; G06V 40/20; H04N 23/611; H04N 23/63; H04N 23/69

(52) U.S. Cl. CPC H04N 23/667; G06V 40/161; G06V 40/28; H04N 23/611; H04N 23/632; H04N 23/69

(57) ABSTRACT

A method provides techniques for detecting, by at least one processor of an electronic device that includes a memory, a first display, and a first image capturing device (ICD), an activation of a mirror mode of the electronic device. Image data is captured from the first image capturing device. The captured image data is rendered and presented on the first display. A human face is detected in the captured image data. In response to detecting a hand movement proximal to a first region of the detected human face, a grooming mode operation is activated that includes autonomously changing an image capturing characteristic of the first ICD to more clearly present the first region of the face, which is presented on the first display.

### BACKGROUND

### 1. Technical Field

The present disclosure generally relates to electronic devices that include electronic displays, and more specifically electronic devices with electronic displays and that support a mirror mode of operation.

### 2. Description of the Related Art

Modern electronic devices such as smartphones and tablet computers often include multiple cameras, including a front-facing camera. A front-facing camera on a smartphone or tablet provides numerous benefits, enhancing both communication and user experience. A front-facing camera can enable high-quality video calls and virtual meetings, allowing users to stay connected with family, friends, and colleagues from anywhere. The camera also can facilitate facial recognition for secure and convenient device unlocking, improving both security and ease of access. Additionally, front-facing cameras can support content creation, enabling users to take self-photos (i.e., ‘selfies’), record vlogs, and livestream effortlessly. Many applications, including augmented reality (AR) and social media filters, also can make use of front-facing cameras for interactive and immersive experiences. Overall, having a front-facing camera enables many use cases for electronic devices.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1A presents a functional block diagram of example components of an electronic device in a communication environment and having hardware and software components that enable the features of the present disclosure to be advantageously implemented, according to one or more embodiments;

FIG. 1B is an additional block diagram representation of the electronic device of FIG. 1A presenting additional components, including components for wireless communications with other devices, according to one or more embodiments;

FIG. 2A illustrates an example of a user holding an electronic device in order to operate the electronic device in a mirror mode, according to one or more embodiments;

FIG. 2B illustrates an example mirror image displayed on the electronic device of FIG. 2A, according to one or more embodiments;

FIG. 2C illustrates an example of a user performing hand movement associated with applying lipstick, to cause an electronic device to enter a grooming mode, according to one or more embodiments;

FIG. 2D illustrates an example mirror image displayed on the electronic device of FIG. 2C, showing an enlarged/magnified section of captured image data that is focused on the user application of lipstick, according to one or more embodiments;

FIG. 3A illustrates another example of a user operating an electronic device in a mirror mode, according to one or more embodiments;

FIG. 3B illustrates an example mirror image displayed on an electronic device based on the user activity shown in FIG. 3A, according to one or more embodiments;

FIG. 3C illustrates an example of the user depicted in FIG. 3A performing a first hand movement associated with application of blush, to cause an electronic device to enter a grooming mode, according to one or more embodiments;

FIG. 3D illustrates an example magnified segment of a mirror image displayed on the electronic device based on the user activity of applying blush as shown in FIG. 3C, according to one or more embodiments;

FIG. 3E illustrates an example of the user depicted in FIG. 3A performing a second hand movement associated with application of lipstick, to cause an electronic device already in grooming mode to render and present a second enlarged section of a captured image, according to one or more embodiments;

FIG. 3F illustrates an example magnified different segment of a mirror image displayed on the electronic device based on the user activity of applying lipstick, shown in FIG. 3E, according to one or more embodiments;

FIG. 4 illustrates an exemplary user interface for grooming mode configuration, according to one or more embodiments;

FIG. 5 depicts a flowchart of a computer-implemented method for implementing a grooming mode on an electronic device, according to one or more embodiments; and

FIG. 6 depicts a flowchart of a computer-implemented method with additional embodiments for implementing a grooming mode on an electronic device, indicating entry and exit of grooming mode, according to one or more embodiments.

### DETAILED DESCRIPTION

According to aspects of the present disclosure, an electronic device, a method, and a computer program product provide techniques for automatically entering a grooming mode on an electronic device with a camera and display, based on user actions. Many people make use of a camera on their electronic device to enter a mode of operation where the user can observe themselves live on a display of the electronic device, typically referred to as ‘selfie mode.’ While the selfie mode can be used for creating content, as well as communicating via video calls, another use case for the selfie mode of operation is to use the camera as a mirror. The use of selfie mode for the specific purposes of checking one's appearance can be referred to as ‘mirror mode’. In mirror mode, the primary function is to allow a user to see himself or herself as if they were facing a physical mirror. Studies point out that many users rely on a mirror mode of operation using their electronic device for applying touch ups to makeup or simply to verify if they are aesthetically pleasing.

Physical appearance is more than just vanity but a cornerstone of our social interactions. Many studies have shown that individuals who are closer to the beauty standards are better treated in nearly any circumstances. In modern society, self-grooming is prevalent for both men and women. While an electronic device with a front-facing camera can serve as a mirror substitute, making the electronic device reliable and efficient for such checks remains a challenge. Users often struggle with the inconvenience of adjusting their electronic device or moving the electronic device around their face to focus on specific areas, especially for tasks like fixing hair or applying makeup. These shortcomings greatly diminish the ease and precision of the experience.

The disclosed embodiments address the aforementioned issues by detecting that the user is performing an action that includes a facial interaction and/or hand movement near the face. In response to detecting the facial interaction and/or hand movement, the electronic device automatically presents a zoomed-in region of interest based on the facial interaction and/or hand movements. Thus, the area of interest is shown enlarged or magnified on the display, simplifying important grooming tasks. As an example, when a user applies lipstick, checks condition of teeth, or other action taking place near the mouth of a user, the zoomed-in area that is rendered and presented can include the user's mouth. Similarly, when a user applies mascara, the zoomed-in area that is rendered and presented can include the user's eyes, or the specific eye, including the eyelash to which mascara is being applied.

According to one aspect, activation of a mirror mode is detected. In one or more embodiments, the mirror mode can be enabled by the user via a user interface, voice command, pressing of a button, or other suitable technique. Once in mirror mode, image data is captured from an image capturing device, and is rendered and presented on a display of the electronic device, serving as a mirror. Depending on the camera configuration, a mirror transform may be applied to the image data prior to rendering and presenting the image data, so that the image data appears as a mirror image for the user. A human face is detected in the image data. Hand motion is detected within the image data, where the hand motion can be proximal to a region of the face. In response to detecting the hand motion and/or other motions, a grooming mode is activated, in which a section of the image data is rendered and presented in a zoomed-in manner, such that a particular region of interest is displayed enlarged/magnified. In one or more embodiments, the region of interest can change dynamically as the user performs different actions. As an example, when a user uses his hand to adjust or smooth his eyebrows, the enlarged region that is displayed can include the eyes of the user. If the user then moves his hand to his mustache to smooth his mustache, the enlarged region that is displayed automatically changes to include the mouth of the user. In this way, the grooming mode of operation provided by disclosed embodiments can enhance the user experience associated with using an electronic device as a mirror.

One or more embodiments can provide an electronic device that includes: at least one display, including a first display embedded in a first surface of a device housing; at least one image capturing device (ICD), including a first image capturing device embedded in the first surface of the device housing; a memory having stored thereon a grooming mode (GM) module; and at least one processor communicatively coupled to the at least one display, the at least one image capturing device, and the memory, the at least one processor executing program code of the GM module, and is configured to cause the electronic device to: in response to activation of a mirror mode: capture image data from the first image capturing device; render and present the captured image data on the first display; detect a human face in the captured image data; and in response to detecting a hand movement proximal to a first region of the detected human face, activate a grooming mode operation comprising autonomously changing an image capturing characteristic of the first ICD to more clearly present the first region of the face on the first display.

One or more embodiments can provide a method that includes detecting, by at least one processor of an electronic device that includes a memory, a first display, and a first image capturing device (ICD), an activation of a mirror mode of the electronic device; capturing image data from the first image capturing device; rendering and presenting the captured image data on the first display; detecting a human face in the captured image data; and in response to detecting a hand movement proximal to a first region of the detected human face, activating a grooming mode operation comprising autonomously changing an image capturing characteristic of the first ICD to more clearly present the first region of the face, which is presented on the first display.

Further embodiments can provide a computer program product including: a non-transitory computer readable medium; and program code on the computer readable medium that when processed by a processor of an electronic device configures the processor to perform functions of the above-described method.

The above descriptions contain simplifications, generalizations and omissions of detail and is not intended as a comprehensive description of the claimed subject matter but, rather, is intended to provide a brief overview of some of the functionality associated therewith. Other systems, methods, functionality, features, and advantages of the claimed subject matter will be or will become apparent to one with skill in the art upon examination of the figures and the remaining detailed written description. The above as well as additional objectives, features, and advantages of the present disclosure will become apparent in the following detailed description.

Each of the above and below described features and functions of the various different aspects, which are presented as operations performed by the processor(s) of the communication/electronic devices are also described as features and functions provided by a plurality of corresponding methods and computer program products, within the various different embodiments presented herein. In the embodiments presented as computer program products, the computer program product includes a non-transitory computer readable storage device having program instructions or code stored thereon, and configuring the electronic device and/or host electronic device to complete the functionality of a respective one of the above-described processes when the program instructions or code are processed by at least one processor of the corresponding electronic/communication device, such as is described above.

In the following description, specific example embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. It is also to be understood that other embodiments may be utilized and that logical, architectural, programmatic, mechanical, electrical and other changes may be made without departing from the general scope of the disclosure. The following detailed description is, therefore, not to be taken in a limiting sense, and the scope of the present disclosure is defined by the appended claims and equivalents thereof.

References within the specification to “one embodiment,” “an embodiment,” “embodiments”, “some embodiments”, or “one or more embodiments” are intended to indicate that a particular feature, structure, or characteristic described in connection with the embodiment is included in at least one implementation (embodiment) of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various aspects are described which may be aspects for some embodiments but not for other embodiments.

The terminology used herein is for the purpose of describing particular embodiments only and is not intended to be limiting of the disclosure. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Moreover, the use of the terms first, second, etc. do not denote any order or importance, but rather the terms first, second, etc. are used to distinguish one element (e.g., a person or a device) from another.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be provided its broadest interpretation given the context in which that term is utilized.

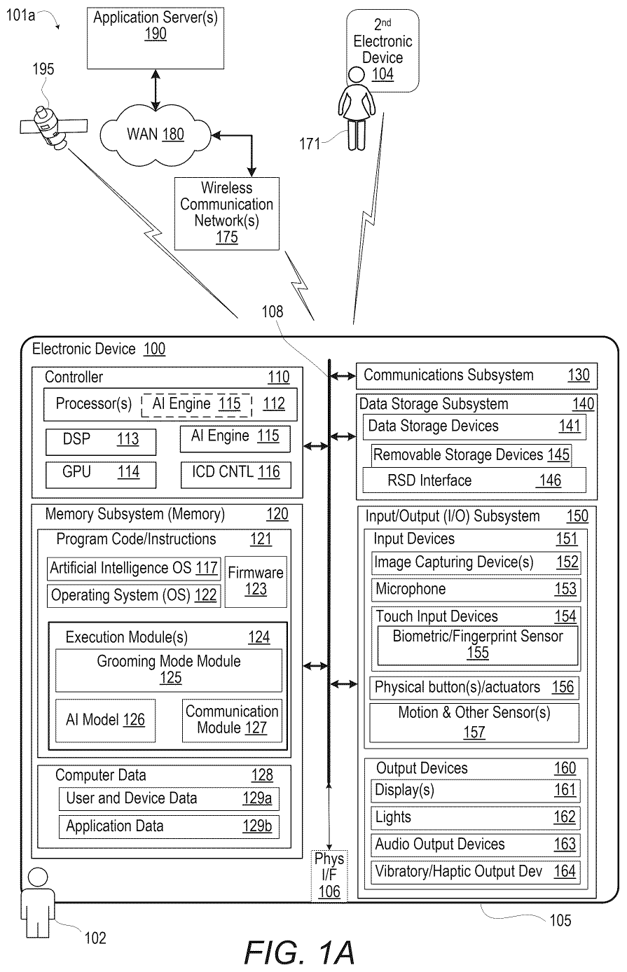

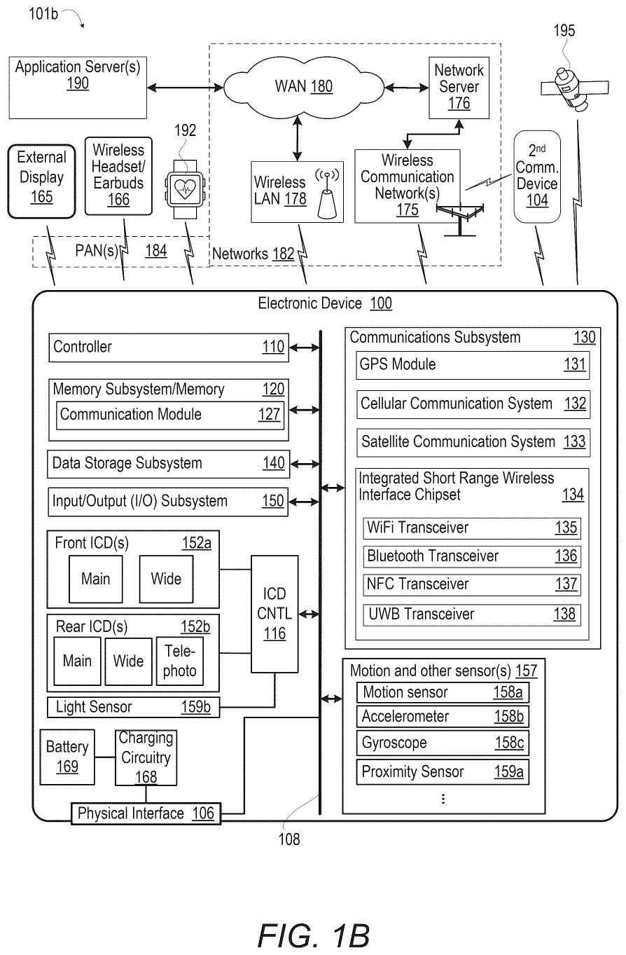

Those of ordinary skill in the art will appreciate that the hardware components and basic configuration depicted in the following figures may vary. For example, the illustrative components within electronic device 100 (FIG. 1A-1B) are not intended to be exhaustive, but rather are representative to highlight components that can be utilized to implement the present disclosure. For example, other devices/components may be used in addition to, or in place of, the hardware depicted. The depicted example is not meant to imply architectural or other limitations with respect to the presently described embodiments and/or the general disclosure. Throughout this disclosure, the terms ‘electronic device’, ‘communication device’, and ‘electronic communication device’ may be used interchangeably, and may refer to devices such as smartphones, tablet computers, and/or other computing/communication devices.

Within the descriptions of the different views of the figures, the use of the same reference numerals and/or symbols in different drawings indicates similar or identical items, and similar elements can be provided similar names and reference numerals throughout the figure(s). The specific identifiers/names and reference numerals assigned to the elements are provided solely to aid in the description and are not meant to imply any limitations (structural or functional or otherwise) on the described embodiments.

Referring now to the figures and beginning with FIG. 1A, there is illustrated a block diagram of an example electronic device 100 in communication environment 101a and having hardware and software components, which enable the features of the present disclosure to be advantageously implemented, according to one or more embodiments.

Examples of electronic device 100 can include, but are not limited to, mobile devices, a notebook computer, a mobile phone, a smart phone, a digital camera with enhanced processing capabilities, a smart watch, a tablet computer, and other types of electronic devices. For purposes of this disclosure, electronic device 100 is assumed to be a communication device that can be used to engage in a voice and/or video call with a second communication device. Electronic device 100 can therefore be interchangeably referred to herein as communication device 100.

Electronic device 100 generally includes controller 110, memory (or memory subsystem) 120, communication subsystem 130, data storage subsystem 140, input/output subsystem 150, all contained within or extended from an exterior surface of device housing 105. Controller 110 is shown communicatively connected/coupled via system interlink 108 with each of the subsystems 120, 130, 140, and 150, and is directly or indirectly connected with the individual components within each subsystem 120, 130, 140, and 150. System interlink 108 represents internal components that facilitate internal communication by way of one or more shared or dedicated internal communication links, such as internal serial or parallel buses. As utilized herein, the term “communicatively coupled” means that information signals are transmissible through various interconnections, including wired and/or wireless links, between the components. The interconnections between the components can be direct interconnections that include conductive transmission media or may be indirect interconnections that include one or more intermediate electrical components.

Controller 110 includes processor 112, which includes one or more central processing units (CPUs) or data processors. Processor 112 performs many of the features of controller 110 and references to features performed by controller 110 can be interchangeably referred to herein as features of processor 112, and vice-versa. In some embodiments, the various functions associated with controller 110 are integrated into processor 112, and accordingly, references made herein to controller and/or processor are understood to refer to one or both components as providing a single management component within the electronic device 100. For simplicity in describing the features of the electronic device 100, the operational functions provided by one or more of operational components within controller 110, including those provided by processor 112 are collectively described as being performed by controller 110. Collectively, components integrated within controller 110 support computing, classifying, processing, transmitting and receiving of data and information, and presenting of graphical and photographic images within a display.

As illustrated, controller 110 can also include one or more digital signal processors 113 graphics processing units (GPUs) 114, artificial intelligence (AI) engine 115, and image capturing device (ICD) controller 116. In some embodiments, the functionality of each of these additional processing components can be integrated with processor(s) 112. Processor 112 can further include other processors such as auxiliary processor(s) that may act as a low power consumption, always-on sensor hub for physical sensors.

Controller 110 manages, and in some instances directly controls, the various functions and/or operations of electronic device 100. These functions and/or operations include, but are not limited to including, application data processing, communication, location and navigation tasks, image processing, and signal processing. In one or more alternate embodiments, electronic device 100 may use hardware component equivalents for application data processing and signal processing. For example, electronic device 100 may use special purpose hardware, dedicated processors, general purpose computers, microprocessor-based computers, micro-controllers, optical computers, analog computers, dedicated processors and/or dedicated hard-wired logic. Controller 110 can, in some embodiments, also include a hardware acceleration (HA) unit, which can establish direct memory access (DMA) sessions to route network traffic to various elements within electronic device 100 without direct involvement from processor 112 and/or a device operating system 122. Operating system 122 may include or be augmented by device AI operating system (OS) 117 that can include native support for AI-specific hardware such as Neural Processing Units (NPUs) or Tensor Processing Units (TPUs) to optimize performance for AI tasks such as machine learning inference and training.

Memory subsystem (or memory) 120 may include a combination of volatile and non-volatile memory, such as random-access memory (RAM) and read-only memory (ROM). Memory subsystem 120 stores instruction or program code 121 for execution by processor 112 to configure processor 112 (and more generally electronic device 100) to provide the operational functions and features described herein. Instructions/program code 121 (or program code 121 for short) includes instructions for an operating system (OS) 122, firmware 123, such as basic input/output system (BIOS) or Uniform Extensible Firmware Interface (UEFI). Program code 121 includes execution module(s) 124 that collectively provides the various features of the disclosure. Execution module(s) 124 include, without limitation, grooming mode (GM) module 125, which provides the features and operating functionality of the disclosed embodiments when the corresponding program instructions of grooming mode (GM) module 125 are processed by/within processor 112/controller 110.

Execution modules 124 further includes AI model(s) 126. In one or more embodiments, processor 112 can utilize AI models 126 to provide AI functionality of processor-integrated AI engine 115. In other embodiments, AI models 126 are directly utilized by AI engine 115. In one or more embodiments, AI model(s) 126 is integrated as a sub-module within GM module 125 and is trained to support AI features of GM module 125. AI model(s) 126 may include an artificial neural network, a decision tree, a support vector machine, Hidden Markov model, linear regression, logistic regression, Bayesian networks, and so forth. AI model(s) 126 can be individually trained to perform specific tasks and can be arranged in different sets of AI models to generate different types of output. Training of AI model(s) 126 is the process by which AI models are trained to perform specific tasks or achieve certain objectives. The training involves providing the model with a large amount of data and allowing the model to learn from patterns and relationships within that data.

Each of the above-introduced module(s) and/or application(s) provides program instructions/code that are processed by processor 112 and which configures processor 112 (and/or controller 110) and/or other operational components of electronic device 100 to cause the electronic device 100 to perform specific operations and functions, as described herein. Descriptive names assigned to these modules add no functionality and are provided solely to assist in identifying the underlying features performed by processing the different modules. For example, GM module 125 can include program instructions that cause or configure processor 112 to cause electronic device 100 to present a magnified (enlarged) region of interest of a face of a user based on user actions such as hand movement and/or facial expressions. Other features provided by GM module 125 are described in further detail throughout this disclosure.

Program code 121 can further include instructions/code for other applications (not shown) providing different features of/within electronic device 100. In one or more embodiments, program code 121 may be integrated into a distinct chipset or hardware module as firmware that operates separately from other executable program code. Portions of program code 121 may be incorporated into different hardware components that operate in a distributed or collaborative manner.

Memory subsystem 120 also includes computer data 128. During execution of program code 121, processor 112 may access, use, generate, modify, store, or communicate computer data 128, such as user and device data 129a and application data 129b. Computer data 128 may incorporate “data” that originated as raw, real-world “analog” information that consists of basic facts and figures. Computer data 128 includes different forms of data, such as numerical data, images, coding, notes, and financial data, as well as data presenting video, graphics, text, and images. Computer data 128 may originate at electronic device 100 or may be retrieved from a remote device via communications subsystem 130. Electronic device 100 may store, modify, present, or transmit computer data 128.

Communications subsystem 130 includes various components that enable electronic device 100 to communicate with external communication networks and other devices, such as second electronic device 104 and application server(s) 190, etc., via communications subsystem 130. According to one or more embodiments, communication module 127 presented within program code 121 includes instructions supporting the use of communications subsystem 130 to establish communication interfaces enabling communication by electronic device 100 with these external networks and devices.

Data storage subsystem 140 of electronic device 100 includes data storage device(s) 141. Controller 110 is communicatively connected, via system interlink 108, to data storage device(s) 141. Data storage subsystem 140 provides stored versions of program code 121 and computer data 128 on nonvolatile storage that is accessible by controller 110. The program code 121 can be loaded into memory 120 for execution/processing by controller 110. In one or more embodiments, data storage device(s) 141 can include hard disk drives (HDDs), optical disk drives, and/or solid-state drives (SSDs), etc.

Data storage subsystem 140 of electronic device 100 can include removable storage device(s) (RSD(s)) 145, which is received in RSD interface 146. Controller 110 is communicatively connected to RSD 145, via system interlink 108 through RSD interface 146. In one or more embodiments, RSD 145 is a non-transitory computer program product or computer readable storage device that stores program code and associated data, including a copy of GM module 125 and AI model(s) 126, which may be executed by a processor associated with a user device, such as electronic device 100. Controller 110 can access data storage device(s) 141 or RSD(s) 145 to provision electronic device 100 with stored program code 121 and computer data 128 that, when executed/processed by processor 112, the program code configures processor 112 and/or more generally electronic device 100, to provide the various functions described herein.

I/O subsystem 150 includes input devices 151 such as, but not limited to, image capturing device(s) (ICDs) 152, microphone 153, and touch input devices 154 (e.g., touch screens, keys, or buttons) for use by a user to interface with electronic device 100. Touch input devices 154 can include a biometric/fingerprint sensor 155 for biometric input. Biometric/fingerprint sensor 155 can be used to read/receive biometric data, such as fingerprints, to identify or authenticate a user. In some embodiments, the biometric sensor 155 can supplement an ICD (camera), which captures images for user detection/identification via facial recognition.

Input devices 151 may include physical buttons/actuators 156 that can be located on a periphery of the device housing 105. Physical buttons/actuators 156 may provide controls for volume, power, and ICDs 152. Microphone 153 can also be referred to as an audio input device. In some embodiments, microphone 153 may be used for identifying a user via voiceprint, voice recognition, and/or other suitable techniques. Input devices 151 can also include one or more motion or other sensor(s) 157, which are further defined in the FIG. 1B description which follows.

With reference to FIG. 1B, as illustrated, motion and other sensor(s) 157 of electronic device 100 include, but are not limited to, one or more motion sensor(s) 158a, one or more accelerometers 158b, one or more gyroscopes 158c, and proximity sensor 159a, etc. Motion sensor(s) 158a detect movement of electronic device 100 and provide motion data to processor 112 indicating the spatial orientation, position and movement of electronic device 100. Accelerometers 158b measure linear acceleration of movement of electronic device 100 in multiple axes (X, Y and Z). For example, accelerometers 158b can include three accelerometers, where one accelerometer measures linear acceleration in the X axis, one accelerometer measures linear acceleration in the Y axis, and one accelerometer measures linear acceleration in the Z axis. Accelerometers 158b can be used to calculate the orientation/position of electronic device 100 relative to the earth and can also be referred to as a gravity sensor. Gyroscope 158c measures rotation or angular rotational velocity of electronic device 100. Proximity sensor 159a senses the presence of nearby objects. In one embodiment, proximity sensor 159a can be an infrared (IR) sensor that detects the presence of a nearby object, such as when electronic device 100 is in a pocket of a user. Electronic device 100 can also include one or more light sensors 159b, which detects the luminance and/or intensity (i.e., the amount) of ambient light surrounding the electronic device 100.

Referring again to FIG. 1A, I/O subsystem 150 includes output devices 160 such as, but not limited to, display(s) 161, lights 162, audio output devices 163, and vibratory and/or haptic output devices 164. In one or more embodiments, electronic device 100 includes an integrated display 161 which incorporates a tactile, touch screen interface that can receive a user's tactile/touch input. As a touch screen device, integrated display 161 allows a user to provide input to and/or to control electronic device 100 by touching features within a user interface presented on integrated display 161. Tactile, touch input device 154 can include a touch screen interface. The touch screen interface can include one or more virtual buttons or selectable affordances. In one or more embodiments, when a user 102 applies a finger or stylus on the touch screen interface (154) in the region demarked by the virtual button, the touch of the region causes the processor 112 to execute code to implement a function associated with the virtual button. In some implementations, integrated display 161 is integrated into a front surface of electronic device housing 105 along with front image capturing devices (not specifically shown), while the higher quality ICDs are located on a rear surface of device housing 105. Other embodiments provide multiple integrated displays within electronic device 100 and references to display(s) 161 are assumed to refer to one or all of these multiple integrated displays.

Vibration/haptic output device 164 can cause electronic device 100 to vibrate or shake when activated. Vibration/haptic output device 164 can be activated during an incoming call or message in order to provide an alert or notification to a user of electronic device 100. In one or more embodiments, integrated display 161, audio output devices (or speakers) 163, and vibration/haptic device 164 can generally and collectively be referred to as output devices.

With reference again to FIG. 1B and with continuing reference to FIG. 1A, there is presented another view of electronic device 100 with components enabling electronic device 100 to function as a mobile communication device, within an expanded communication environment 101b. In addition to the functional and operational components already presented by and described within the description of FIG. 1A, FIG. 1B further illustrates expanded communications subsystem 130 with additional communication components and interfaces enabling electronic device 100 to perform wireless communications within an expanded communication environment 101b that includes other devices.

Communications subsystem 130 includes global positioning system (GPS) module 131 that enables electronic device 100 to communicate with and receive GPS location data from GPS satellite(s) 195. In one or more embodiments, GPS module 131 receives geospatial input from GPS broadcasts of time data and location data from GPS satellite(s) 195 to obtain geospatial location information about the physical location of electronic device 100.

In one or more embodiments, controller 110, via communications subsystem 130, performs multiple types of cellular over-the-air (OTA) or non-cellular wireless communication, such as by using a Bluetooth connection or other personal access network (PAN) connection. As shown, communications subsystem 130 includes cellular communication system 132, which includes at least one radio frequency RF front end coupled to one or more antennas. In one or more embodiments, cellular communication system 132 can include a communication module with one or more baseband processors or digital signal processors, one or more modems, and a radio frequency (RF) front end having one or more transmitters and one or more receivers. In one or more embodiments, controller 110, via communications subsystem 130, may communicate via an OTA cellular connection with radio access networks (RANs) over a cellular wireless communication network (CWCN) 175. CWCN 175 can be a terrestrial network and include a plurality of base stations and associated network server(s) 176, in one embodiment. Cellular communication system 132 allows electronic device 100 to communicate wirelessly with CWCN 175 via transmissions of communication signals (represented as lightning bolts) to and from network communication devices, such as base stations or cellular nodes, of CWCN 175. Alternatively, or in addition, CWCN 175 can include a satellite network, and electronic device 100 connects to CWCN 175 using satellite communication system 133. Cellular communication system 132 and satellite communication system 133 enable electronic device 100 to engage in long distance wireless communication capabilities.

In one or more embodiments, communications subsystem 130 includes integrated short range wireless interface chipset 134 having one or more of Wi-Fi transceiver (TxRx) 135, Bluetooth (BT) TxRx 136, near field communication (NFC) transceiver 137, and ultra-wideband (UWB) transceiver 138. In one or more embodiments, the short-range communication devices are not integrated on a single chipset but can be separately provided hardware components. In one or more embodiments, electronic device 100 can communicate wirelessly with external wireless devices, such as a Wi-Fi router of a wireless local area network (WLAN) 178 and/or second electronic device 104, via one or more short-range wireless interface(s). Second electronic device 104 can be a communication device, such as a smartphone, and/or can be similarly configured as electronic device 100. Second user 171 may operate second electronic device 104. In one or more embodiments, electronic device 100 can receive Internet or Wi-Fi based calls, text messages, multimedia messages, and other notifications via a combination of wireless and wired networks (generally networks 182).

In one or more embodiments, networks 182 can include CWCN 175, WLAN 178, and Wide Area Network (WAN) 180, such as the Internet. In one or more embodiments, WAN 180 can enable electronic device 100 to access application servers 190, which can provide a downloadable version of GM module 125 and/or access to other applications, online transactions, and resources. In one or more embodiments, networks 182 can also include personal area networks (PAN) 184, which are individually created with second devices via one of short-range wireless devices from among Wi-Fi TxRx 135, BT TxRx 136, NFC transceiver 137, and UWB transceiver 138. Example second devices include external display 165, wireless headset 166, and wearable computing device 192. External display 165 can be a stand-alone monitor/display or a display integrated into a second electronic device, such as a laptop computer. In at least one embodiment, connection to the external display 165 can be wired and can include an intermediate connection device, such as a docking station device. In one or more embodiments, wearable computing device 192, such as a smartwatch, fitness tracker, or the like, may be paired with electronic device 100, and provide biometric data such as heart rate, breathing rate, and the like, to the electronic device 100 via the paired communication link.

Electronic device 100 also includes a physical interface 106. Physical interface 106 of electronic device 100 can serve as an input/output data port and can be used as a power supply port that is coupled to charging circuitry 168 which feeds electrical power to device battery 169 to enable recharging of device battery 169 and/or powering of electronic device 100. As a data port, physical interface 106 can enable electronic device 100 to be physically coupled via a cable or docking station port to a second device, such as external display 165.

FIG. 1B also presents additional details of ICD(s) 152 of electronic device 100. Throughout the disclosure, the term image capturing device (ICD) is synonymous with and/or utilized interchangeably with any one of the cameras of electronic device 100. ICD(s) (or cameras) 152 includes front cameras 152a and rear cameras 152b. In one embodiment, each of front cameras 152a and rear cameras 152b are communicatively coupled to ICD controller 116. ICD controller 116 supports the processing of image data from front cameras 152a and rear cameras 152b. Front cameras 152a can include a main camera and a wide-angle camera. Rear ICD(s) can include a main camera, a wide-angle camera, and a telephoto camera. Both sets of cameras 152 include image sensors that can capture images that are within the field of view (FOV) of each respective camera 152. In one or more embodiments, one or more of the cameras can be utilized to enable biometric authentication using facial image and/or iris scan recognition.

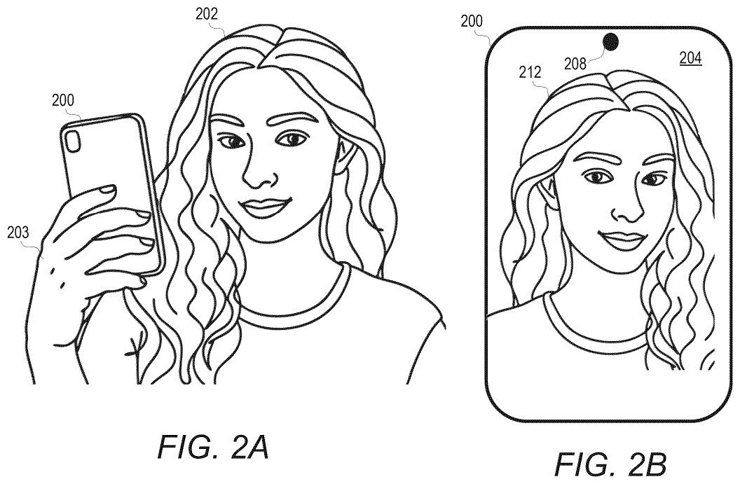

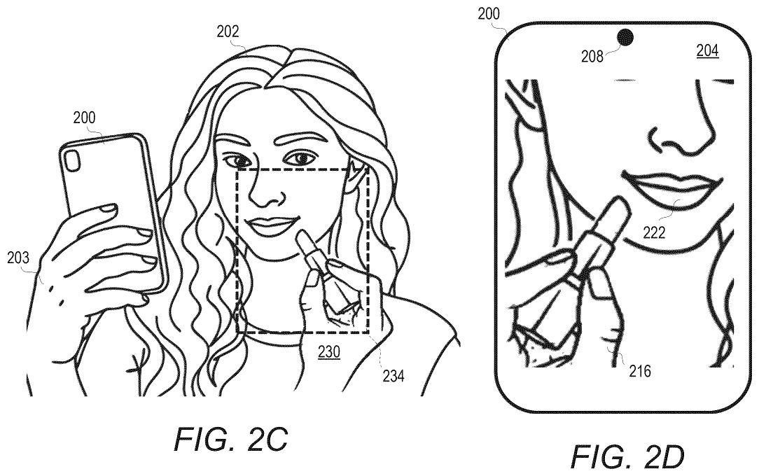

FIG. 2A illustrates an example of a user holding an electronic device in order to operate the electronic device in a mirror mode, according to one or more embodiments. User 202 is holding electronic device 200 with hand 203. In embodiments, electronic device 200 can be similar to electronic device 100 shown in FIG. 1A and FIG. 1B. FIG. 2B illustrates an example mirror image displayed on the electronic device of FIG. 2A, according to one or more embodiments. As can be seen in FIG. 2B, device 200 includes display 204, and front-facing camera 208. The front-facing camera 208 acquires image data of user 202 (FIG. 2A), and the camera controller and/or GPU renders and presents the image data on the display 204, resulting in a mirror image of the user, indicated as 212, being included in the image data that is rendered and presented on display 204.

FIG. 2C illustrates an example of a user performing hand movement associated with applying lipstick, to cause an electronic device to enter a grooming mode, according to one or more embodiments. As shown in FIG. 2C, the user 202 is applying lipstick with her other hand 230, while still holding the electronic device 200 with hand 203. At least one processor within electronic device 200 can determine a region of interest 234 based on the location and/or detected movement of hand 230.

FIG. 2D illustrates an example mirror image displayed on the electronic device of FIG. 2C, showing an enlarged/magnified section of captured image data that is focused on the user application of lipstick, according to one or more embodiments. As can be seen in FIG. 2D, device 200 includes display 204, and front-facing camera 208. The front-facing camera 208 acquires image data of user 202 (FIG. 2C), and while the device is in grooming mode, the ICD controller and/or GPU renders and presents the region of interest 234 (FIG. 2C) in a zoomed-in manner, effectively magnifying the region of interest 234 (FIG. 2C) when rendering and presenting the region of interest 234 on the display 204. This process results in the region of interest 234 shown in FIG. 2C being included in the image data that is rendered and presented on display 204, shown as 216 in FIG. 2D. In this way, the user 202 can now easily view the details of the area around the lips 222 for convenience during application of lipstick. One or more embodiments can include adjusting a zoom level to increase a size of the first region displayed on the first display, such that the first region occupies a majority of the first display.

In one or more embodiments, the detection of hand 230, and/or relative motion of hand 230, as well as determining a region of interest 234, can be performed by computer vision techniques and/or AI-enabled techniques. In one or more embodiments, the detection of hands and faces is performed utilizing Haar Cascade classifiers. In embodiments, the hand movement comprises performing a Haar Cascade hand movement recognition process. One or more embodiments may utilize deep learning-based object detection models, such as YOLO (You Only Look Once), Faster R-CNN, or MediaPipe Hands and Face Detection APIs, instead of, or in addition to, the use of Haar Cascade classifiers. Once the hand and face are detected, one or more embodiments can apply motion estimation techniques to determine when the hand is moving toward, or near, a specific region of the face.

One or more embodiments may utilize pose estimation. Pose estimation techniques, such as MediaPipe Pose, OpenPose, or BlazePose, detect key points on the face, hands, and body. These models provide a set of 2D or 3D coordinates for key points, which can be analyzed to determine proximity between the hands and the face. In one or more embodiments, the pose estimation techniques may include identification of key points on the hands (e.g., fingertips, palm center) and the face (e.g., nose, chin, cheeks, forehead, lips). In one or more embodiments, the pose estimation techniques may include computing the Euclidean distance between hand key points and facial key points. In embodiments, the hand movement comprises performing a pose estimation gesture recognition process. One or more embodiments can utilize optical flow, frame differencing, and/or keypoint motion estimation techniques. By analyzing the trajectory of the hand, disclosed embodiments can infer when the hand is approaching the mouth, eyes, and/or other facial regions.

Once the hand is detected near a particular facial feature (e.g., the lips), a region of interest (ROI) around the interaction area can be defined. This ROI can be dynamically adjusted based on bounding box detection, facial landmark detection, and/or other suitable techniques. One or more embodiments may perform adaptive cropping and rescaling to crop the ROI and enlarge the ROI. One or more embodiments may utilize interpolation techniques such as bicubic interpolation for rescaling. One or more embodiments may utilize neural upscaling techniques such as a super-resolution GAN (generative adversarial network) to enable improved magnification. In one or more embodiments, AI engine 115 (FIG. 1A) may be used to perform one or more image enhancement processes, including neural upscaling, to produce the magnified images.

Disclosed embodiments can utilize optical zoom techniques that include adjusting the focal length of a camera lens to enlarge images without losing image quality. The optical zoom can include physically moving lens elements within the camera to change the field of view. Disclosed embodiments can employ digital zoom techniques that utilize software to enlarge an image by cropping and scaling the pixels. Instead of adjusting the lens, the zoom effect is achieved by increasing the pixel size, and may include using interpolation techniques to estimate missing details. One or more embodiments may utilize a hybrid zoom technique that combines optical zoom and digital zoom to achieve higher magnification while maintaining image quality. Regardless of the zoom technique used, disclosed embodiments can automatically render and present a region of interest with magnification, aiding in common grooming tasks such as makeup, hair grooming, teeth cleaning, and more. One or more embodiments can include increasing a pixel resolution value to provide additional pixels and higher resolution in the first region of the captured image displayed on the first display.

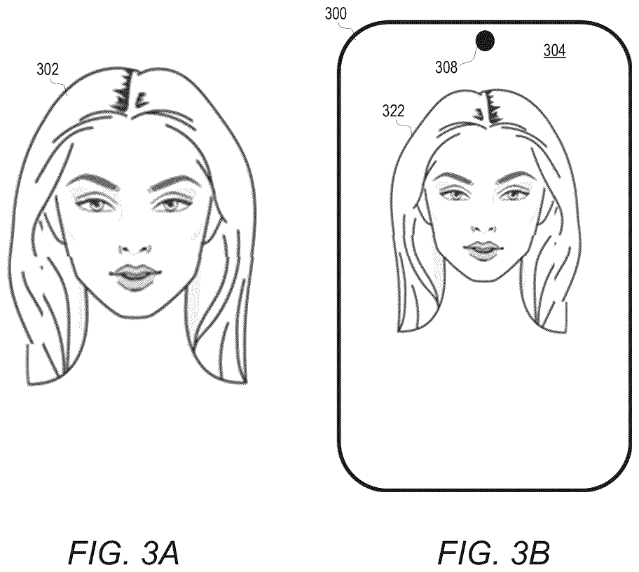

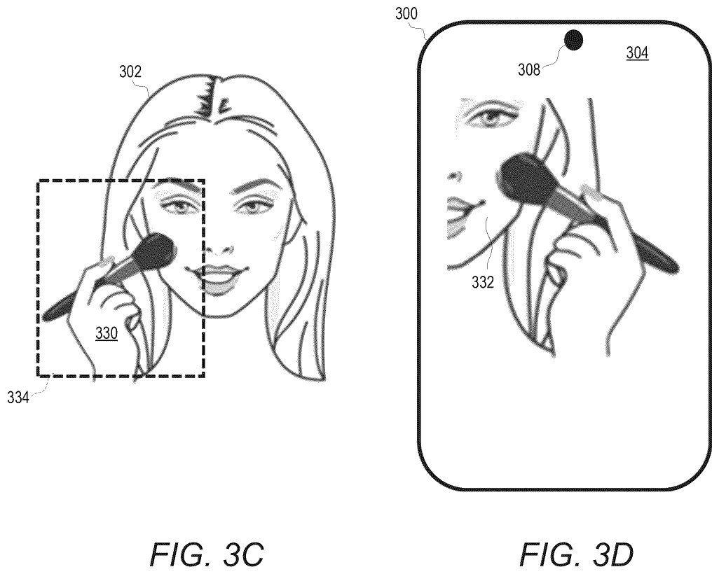

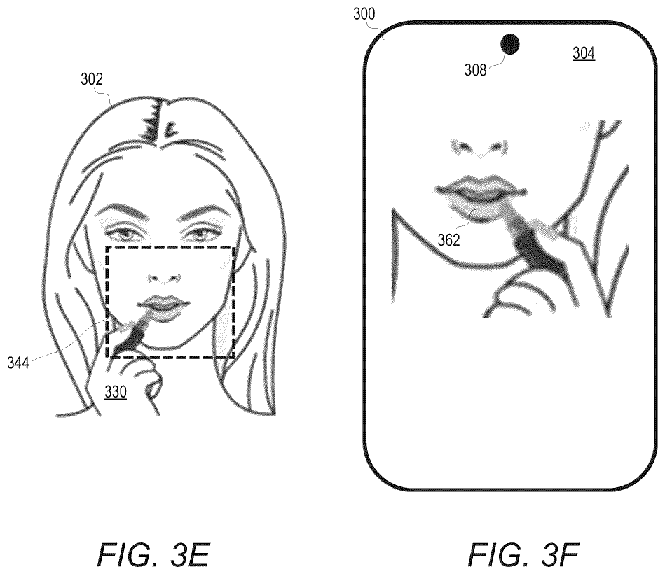

FIG. 3A illustrates another example of a user 302 operating an electronic device in a mirror mode, according to one or more embodiments. FIG. 3B illustrates an example mirror image 322 displayed on an electronic device based on the user activity shown in FIG. 3A, according to one or more embodiments. In some embodiments, electronic device 300 can be similar to electronic device 100 shown in FIG. 1A and FIG. 1B. As can be seen in FIG. 3B, device 300 includes display 304, and front-facing camera 308. The front-facing camera 308 acquires image data of user 302 (FIG. 3A), and the at least one processor of the device 300 renders and presents the image data on the display 304, resulting in a mirror image of the user, indicated as 322, being included in the image data that is rendered and presented on display 304.

FIG. 3C illustrates an example of the user depicted in FIG. 3A performing a first hand movement associated with application of blush, to cause an electronic device, which is in the mirror mode, to enter a grooming mode, according to one or more embodiments. As shown in FIG. 3C, the user 302 is applying blush with her hand 330. At least one processor within electronic device 300 can determine a region of interest 334 based on the location and/or detected movement of hand 330 using techniques such as those previously described.

FIG. 3D illustrates an example magnified segment of a mirror image displayed on the electronic device based on the user activity of applying blush shown in FIG. 3C, according to one or more embodiments. As can be seen in FIG. 3D, device 300 includes display 304, and front-facing camera 308. The front-facing camera 308 acquires image data of user 302 (FIG. 3C), and, while the device is in grooming mode, and the at least one processor within device 300 renders and presents the region of interest 334 (FIG. 3C) in a zoomed-in manner, effectively magnifying the region of interest 334 (FIG. 3C) when rendering and presenting the region of interest 334 on the display 304. This process results in the region of interest 334 of the user being included in the image data that is rendered and presented on display 304. In this way, the user 302 can now easily view the details of the area around the cheek 332 for convenience during application of blush.

FIG. 3E illustrates an example of the user depicted in FIG. 3A performing a second hand movement associated with application of lipstick, to cause an electronic device that is already in grooming mode to render and present a second enlarged section of a captured image, according to one or more embodiments. As shown in FIG. 3E, the user 302 is applying lipstick with her hand 330. At least one processor within electronic device 300 can determine a second region of interest 344 based on the location and/or detected movement of hand 330 using techniques such as those previously described. In some cases, the first region of interest and the second region of interest may have some overlap with each other. In other cases, there may be no overlap between the first region of interest and the second region of interest.

FIG. 3F illustrates an example magnified different segment of a mirror image displayed on the electronic device based on the user activity of applying lipstick, shown in FIG. 3E, according to one or more embodiments. As can be seen in FIG. 3F, device 300 includes display 304 and front-facing camera 308. The front-facing camera 308 acquires image data of user 302 (FIG. 3E), and, while the device remains in grooming mode, the at least one processor of device 300 renders and presents the second region of interest 344 (FIG. 3E) in a zoomed-in manner, effectively magnifying the region of interest 344 (FIG. 3E) when rendering and presenting the region of interest 344 on the display 304. This process results in the region of interest 344 of the user being included in the image data that is rendered and presented on display 304. In this way, the user 302 can now easily view the details of the area around the lips 362 for convenience during application of lipstick.

Thus, as depicted in the sequence of FIG. 3A-FIG. 3F, a user can place her hand near a first region of her face (FIG. 3C), resulting in a first region of interest 334 being automatically rendered and presented on the display of the electronic device in a magnified manner (FIG. 3D). Then the user can move her hand near a second region of her face (FIG. 3E), resulting in a second region of interest 344 being automatically rendered and presented on the display of the electronic device in a magnified manner (FIG. 3F). Accordingly, disclosed embodiments provide a grooming mode feature that functions as a smart mirror with automatic zooming based on hand activity, providing significant benefits for personal grooming, makeup application, and skin care. For example, users can effortlessly focus on specific facial areas while applying cosmetics. Instead of manually adjusting the zoom or positioning the camera, the grooming mode feature of disclosed embodiments automatically detects hand movements and highlights the relevant area. As depicted in the examples of FIG. 3A-3F, when applying blush, the camera zooms in on the cheek to enable the user to view details of blush application. After the blush application, when applying lipstick, the zoom shifts to the mouth area, enabling accuracy in the application of lipstick. One or more embodiments can include: detecting a second hand movement proximal to a second region of the face; and changing a directional focus and zoom factor of the first ICD such that the second region of the face is rendered and more vividly presented on the electronic display. Thus, the grooming mode provides hands-free, dynamic zooming that eliminates distractions, improving ease of application of cosmetics, while reducing the need for additional mirrors or manual camera adjustments. The examples depicted in FIG. 2-3 are merely exemplary activities that can activate grooming mode. Other activities, such as checking beard, mustache, applying eyebrow pencil, and more, can also activate grooming mode. Embodiments can include monitoring a field of view of the first ICD for a hand movement from a group comprising stroking hair, stroking mustache, stroking beard, applying eyeliner, applying lipstick or lip gloss, rubbing/brushing teeth, and applying eyebrow pencil.

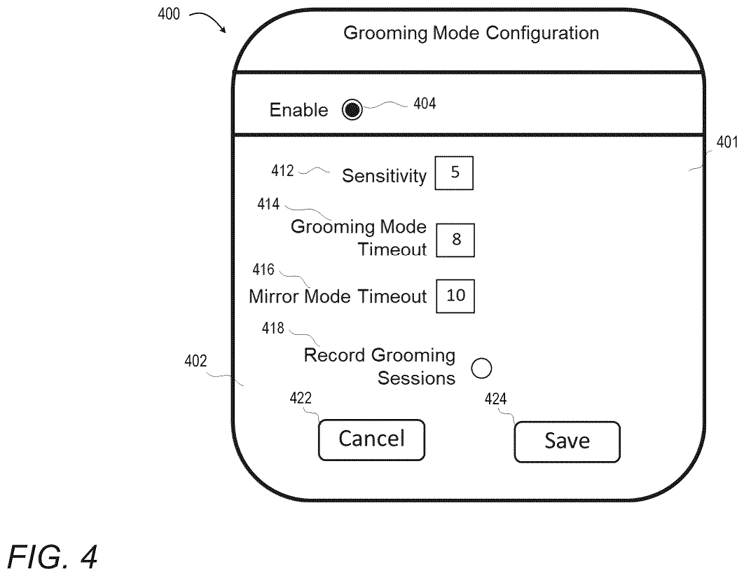

FIG. 4 illustrates an exemplary user interface for grooming mode configuration, according to one or more embodiments. Device 400 includes display 402 on which user interface 401 is rendered and presented. The user interface 401 can include an option to enable the grooming mode feature 404, which is indicated as selected in FIG. 4. The user interface 401 can further include one or more user-customizable parameters. The user-customizable parameters can include a sensitivity parameter 412. In one or more embodiments, the sensitivity parameter 412 may be entered as a numerical value on a scale from 1 to 5, 1 to 10, or other suitable range. The sensitivity parameter can adjust detection thresholds within the hand and face detection models. The sensitivity value can vary inversely with a confidence score threshold. In one or more embodiments, a higher sensitivity value can enable detection of features with a lower confidence, allowing for detection in low-light conditions. A lower sensitivity value requires a higher confidence score to detect a hand, reducing false positives. In one or more embodiments, the sensitivity parameter enables fine-tuning of feature detection by adjusting thresholds, motion sensitivity, proximity limits, filtering, and/or sampling rates. The user-customizable sensitivity parameter allows the grooming mode feature to adapt to different lighting conditions, user preferences, and environmental noise, providing a customized experience for various applications.

The user-customizable parameters can include a grooming mode timeout option 414. In one or more embodiments, the grooming mode timeout is specified as an integer number of seconds during which no hand movement is detected, and the electronic device returns to mirror mode from grooming mode. In mirror mode, the entire face of the user may be shown (e.g., FIG. 3B), whereas in grooming mode, an enlarged area of the face is shown (e.g., FIG. 3D). The user-customizable parameters can include a mirror mode timeout option 416. In one or more embodiments, the mirror mode timeout is specified as an integer number of seconds during which, no human face is detected, and the electronic device exits mirror mode and returns to a normal mode of operation, such as displaying a home screen, lock screen, a previously used application, or other suitable user interface.

The user interface 401 can include an option to record grooming sessions 418, which is indicated as not selected in FIG. 4. The option to record grooming sessions can be useful for beauty influencers, makeup artists, and/or skincare educators. The option to record grooming sessions can simplify content creation by automatically tracking and highlighting important steps of a makeup routine. Instead of manually adjusting the zoom during recording, the grooming mode automatically zooms in on regions of interest, based on the user's hand movements, ensuring that viewers can observe the most relevant details of such videos. One or more embodiments can include creating a recording of the captured image data obtained while the electronic device is operating in a mirror mode or grooming mode, and storing the recording in the memory of the electronic device.

A cancel option 422, when invoked, discards unsaved settings of the user interface of FIG. 4, and exits the user interface. A save option 424, when invoked, saves the settings of the user interface of FIG. 4 to memory, and exits the user interface. More, fewer, and/or different options may be present in one or more embodiments.

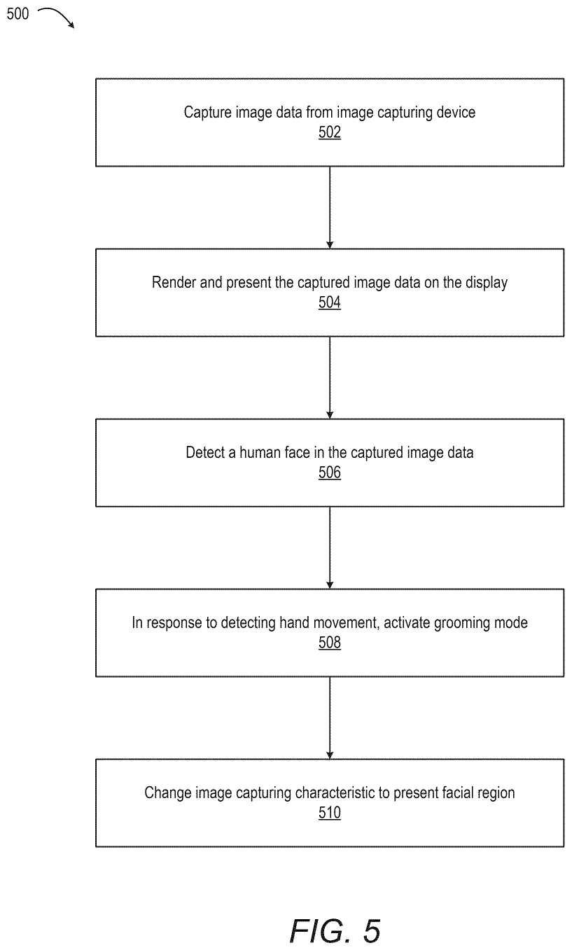

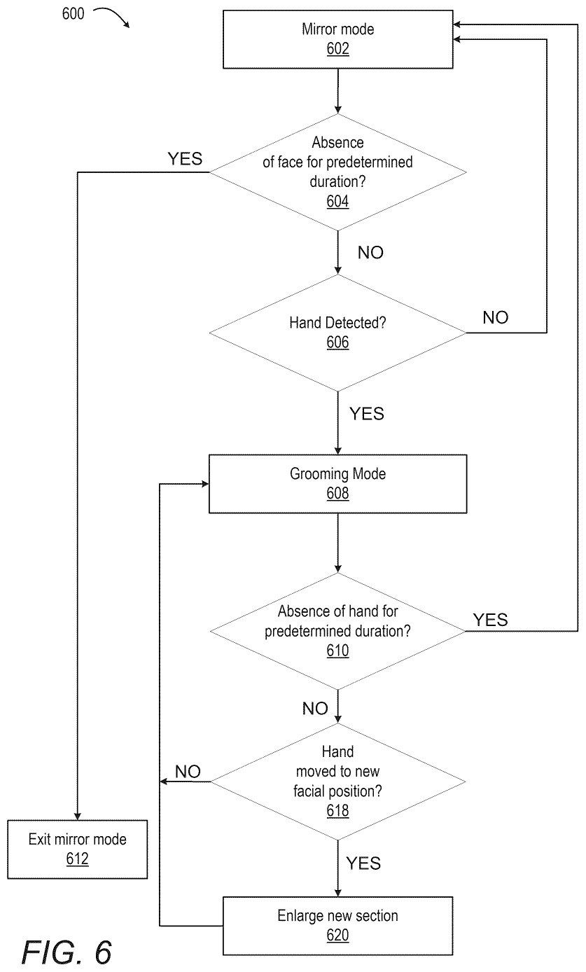

Referring now to the flowcharts presented by FIG. 5 and FIG. 6, the descriptions of the methods in FIG. 5 and FIG. 6 are provided with general reference to the specific components and features illustrated within the preceding FIG. 1-4. Specific components referenced in the methods of FIG. 5 and FIG. 6 may be identical or similar to components of the same name used in describing preceding FIG. 1-4. In one or more embodiments, processor 112 (FIG. 1A) configures electronic device 100 (FIG. 1A) to provide the described functionality of the methods of FIG. 5-FIG. 6 by executing program code for one or more modules or applications provided within system memory 120 of electronic device 100, including grooming mode (GM) module 125.

FIG. 5 depicts a flowchart of a computer-implemented method for implementing a grooming mode on an electronic device, according to one or more embodiments. The method 500 starts at block 502, where image data is captured from an image capturing device, such as a camera. The camera can be a front-facing camera, or any other camera that enables live images of a user to be rendered and presented on a display of the electronic device that the user can view in real-time. The method 500 continues with rendering and presenting the captured image data on the display at block 504. In one or more embodiments, the rendering and presenting of the captured image data on the display can include performing a mirroring transformation (horizontal flip), in order to create a “mirror effect” so that the user sees themself as they would in a physical mirror.

The method 500 continues to block 506, where a human face is detected in the captured image data. In one or more embodiments, the facial detection can include Haar Cascade classifiers, Histogram of Oriented Gradients (HOG) with Support Vector Machines (SVM), Multi-task Cascaded Convolutional Networks (MTCNN), Single Shot MultiBox Detector (SSD) with MobileNet, RetinaFace, YOLO (You Only Look Once), MediaPipe Face Detection, and/or other suitable techniques. The method 500 continues to block 508, where grooming mode is activated, in response to detecting hand movement. The method 500 continues to block 510, where at least one image capturing characteristic is changed to present a facial region. Accordingly, the activation of grooming mode can include presenting a magnified image that corresponds to a region of interest, such as depicted in FIG. 2D, FIG. 3D, and FIG. 3F.

FIG. 6 depicts a flowchart of a computer-implemented method for additional embodiments for implementing a grooming mode on an electronic device, indicating entry and exit of grooming mode, according to one or more embodiments. The method 600 starts at block 602, where a mirror mode is entered. In one or more embodiments, the mirror mode can be entered via a user interface action (e.g., tapping a virtual button), voice command, or other suitable technique. The method 600 continues to block 604, where a check is made to determine if a face has been absent from the image data for a predetermined duration. In one or more embodiments, the predetermined duration can be specified by option 416 shown in FIG. 4. If, at block 604, the absence of a face has been determined to have continued beyond the predetermined duration, the method 600 continues to block 612, where the electronic device exits mirror mode. If, at block 604, the absence of a face has been determined to have not continued beyond the predetermined duration, the method 600 continues to block 606, where a check is made to determine if a hand is detected near the face. If, at block 606, a hand is not detected, the method 600 returns to block 602, and the device remains in mirror mode. If, at block 606, a hand is detected near the face, the method 600 continues to block 608 where grooming mode is entered. The method 600 then continues to block 610, where a check is made to determine if a hand has been absent from the image data for a predetermined duration. In one or more embodiments, the predetermined duration can be specified by option 414 shown in FIG. 4. If, at block 610, the absence of a hand has been determined to have continued beyond the predetermined duration, the method 600 continues to block 602, where the electronic device returns to mirror mode. If, at block 610, the absence of a hand has been determined to have not continued beyond the predetermined duration, the method 600 continues to block 618, where a check is made to determine if a hand has moved to a new facial position. If, at block 618, it is determined that the hand moved to a new facial position, then the method 600 continues to block 620, where a new section of the image is enlarged, and the method 600 then returns to block 608, to remain in grooming mode. An example of the hand moving to a new facial position is depicted in FIG. 3C-3F, where a first section covers the cheek area of a user (334 of FIG. 3C), and a second section covers the lips area of the user (344 of FIG. 3D). If, at block 618, the hand has not moved to a new facial position, then the method 600 returns to block 608, to remain in grooming mode.

The flowcharts, sequences, and configurations presented herein are provided solely for illustrative purposes and are exemplary in nature. These embodiments are not intended to be limiting and may include variations with more, fewer, and/or alternative options, sequences, or features as would be apparent to those skilled in the art.

As can now be appreciated, disclosed embodiments provide techniques for implementing a grooming mode in an electronic device. The techniques can include object detection, motion tracking for estimating hand movement, and region-based zooming using facial landmarks. Disclosed embodiments can automatically detect hand activity near the lips, eyes, and/or other regions of interest, and provide a magnified view. Thus, the grooming mode feature of disclosed embodiments can be useful for applications such as makeup assistance, accessibility tools, and health monitoring.

In the above-described methods, one or more of the method processes may be embodied in a computer readable device containing computer readable code such that operations are performed when the computer readable code is executed on a computing device. In some implementations, certain operations of the methods may be combined, performed simultaneously, in a different order, or omitted, without deviating from the scope of the disclosure. Further, additional operations may be performed, including operations described in other methods. Thus, while the method operations are described and illustrated in a particular sequence, use of a specific sequence or operations is not meant to imply any limitations on the disclosure. Changes may be made with regards to the sequence of operations without departing from the spirit or scope of the present disclosure. Use of a particular sequence is therefore, not to be taken in a limiting sense, and the scope of the present disclosure is defined primarily by the appended claims.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. Computer program code for carrying out operations for aspects of the present disclosure may be written in any combination of one or more programming languages, including an object-oriented programming language, without limitation. These computer program instructions may be provided to a processor of a general-purpose computer, special-purpose computer, or other programmable data processing apparatus to produce a machine that performs the method for implementing the functions/acts specified in the flowchart and/or block diagram block or blocks. The methods are implemented when the instructions are executed via the processor of the computer or other programmable data processing apparatus.

As will be further appreciated, the processes in embodiments of the present disclosure may be implemented using any combination of software, firmware, or hardware. Accordingly, aspects of the present disclosure may take the form of an entirely hardware embodiment or an embodiment combining software (including firmware, resident software, micro-code, etc.) and hardware aspects that may all generally be referred to herein as a “circuit,” “module,” or “system.” Furthermore, aspects of the present disclosure may take the form of a computer program product embodied in one or more computer readable storage device(s) having computer readable program code embodied thereon. Any combination of one or more computer readable storage device(s) may be utilized. The computer readable storage device may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage device can include the following: a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage device may be any tangible medium that can contain or store a program for use by or in connection with an instruction execution system, apparatus, or device.

Where utilized herein, the terms “tangible” and “non-transitory” are intended to describe a computer-readable storage medium (or “memory”) excluding propagating electromagnetic signals, but are not intended to otherwise limit the type of physical computer-readable storage device that is encompassed by the phrase “computer-readable medium” or memory. For instance, the terms “non-transitory computer readable medium” or “tangible memory” are intended to encompass types of storage devices that do not necessarily store information permanently, including, for example, RAM. Program instructions and data stored on a tangible computer-accessible storage medium in non-transitory form may afterwards be transmitted by transmission media or signals such as electrical, electromagnetic, or digital signals, which may be conveyed via a communication medium such as a network and/or a wireless link.

The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

As used herein, the term “or” is inclusive unless otherwise explicitly noted. Thus, the phrase “at least one of A, B, or C” is satisfied by any element from the set {A, B, C} or any combination thereof, including multiples of any element.

While the disclosure has been described with reference to example embodiments, it will be understood by those skilled in the art that various changes may be made and equivalents may be substituted for elements thereof without departing from the scope of the disclosure. In addition, many modifications may be made to adapt a particular system, device, or component thereof to the teachings of the disclosure without departing from the scope thereof. Therefore, it is intended that the disclosure not be limited to the particular embodiments disclosed for carrying out this disclosure, but that the disclosure will include all embodiments falling within the scope of the appended claims.

What is claimed is:

1. An electronic device comprising:
at least one display, including a first display embedded in a first surface of a device housing;
at least one image capturing device (ICD), including a first image capturing device embedded in the first surface of the device housing;
a memory having stored thereon a grooming mode (GM) module; and
at least one processor communicatively coupled to the at least one display, the at least one image capturing device, and the memory, the at least one processor executing program code of the GM module, and is configured to cause the electronic device to:
in response to activation of a mirror mode:
capture image data from the first image capturing device;
render and present the captured image data on the first display;
detect a human face in the captured image data; and
in response to detecting a hand movement proximal to a first region of the detected human face, activate a grooming mode operation comprising autonomously changing an image capturing characteristic of the first ICD to more clearly present the first region of the face on the first display.

2. The electronic device of claim 1, wherein the image capturing characteristic is a zoom level, and the at least one processor is further configured to cause the ICD to adjust a zoom level to increase a size of the first region displayed on the first display, such that the first region occupies a majority of the first display.

3. The electronic device of claim 1, wherein the image capturing characteristic is a pixel resolution value, and the at least one processor is further configured to cause the ICD to increase a pixel resolution value to provide additional pixels and higher resolution in the first region of the captured image displayed on the first display.

4. The electronic device of claim 1, wherein to detect hand movement, the at least one processor further is configured to cause the electronic device to monitor a field of view of the first ICD for a hand movement from a group comprising stroking hair, stroking mustache, stroking beard, applying eyeliner, applying lipstick or lip gloss, rubbing teeth, and applying eyebrow pencil.

5. The electronic device of claim 1, wherein further the at least one processor is configured to cause the electronic device to exit the grooming mode operation and return to the mirror mode in response to not detecting a presence of a hand in the captured image data for a predetermined duration.

6. The electronic device of claim 5, wherein further the at least one processor is configured to cause the electronic device to exit the mirror mode in response to not detecting a presence of the face in the captured image data for a second predetermined duration.

7. The electronic device of claim 1, wherein to detect the hand movement towards a region of the face, the at least one processor is configured to perform a Haar Cascade hand movement recognition process.

8. The electronic device of claim 1, wherein to detect the hand movement, the at least one processor is configured to perform a pose estimation gesture recognition process.

9. The electronic device of claim 1, wherein further the at least one processor is configured to cause the electronic device to:
detect a second hand movement proximal to a second region of the face; and
change a directional focus and zoom factor of the first ICD such that the second region of the face is rendered and more vividly presented on the electronic display.

10. The electronic device of claim 1, wherein further the at least one processor is configured to cause the electronic device to create a recording of the captured image data obtained while the electronic device is operating in a mirror mode or grooming mode, and store the recording in the memory of the electronic device.

11. A method comprising:
detecting, by at least one processor of an electronic device that includes a memory, a first display, and a first image capturing device (ICD), an activation of a mirror mode of the electronic device;
capturing image data from the first image capturing device;
rendering and presenting the captured image data on the first display;
detecting a human face in the captured image data; and
in response to detecting a hand movement proximal to a first region of the detected human face, activating a grooming mode operation comprising autonomously changing an image capturing characteristic of the first ICD to more clearly present the first region of the face, which is presented on the first display.

12. The method of claim 11, further comprising adjusting a zoom level to increase a size of the first region displayed on the first display, such that the first region occupies a majority of the first display.

13. The method of claim 11, further comprising increasing a pixel resolution value to provide additional pixels and higher resolution in the first region of the captured image displayed on the first display.

14. The method of claim 11, further comprising monitoring a field of view of the first ICD for a hand movement from a group comprising stroking hair, stroking mustache, stroking beard, applying eyeliner, applying lipstick or lip gloss, rubbing teeth, and applying eyebrow pencil.

15. The method of claim 11, further comprising exiting the grooming mode operation and returning to the mirror mode in response to not detecting a presence of a hand in the captured image data for a predetermined duration.

16. The method of claim 15, further comprising exiting the mirror mode in response to not detecting a presence of the face in the captured image data for a second predetermined duration.

17. The method of claim 11, wherein detecting the hand movement comprises performing a Haar Cascade hand movement recognition process.

18. The method of claim 11, wherein detecting the hand movement comprises performing a pose estimation gesture recognition process.

19. The method of claim 11, further comprising creating a recording of the captured image data obtained while the electronic device is operating in a mirror mode or grooming mode, and storing the recording in the memory of the electronic device.

20. A computer program product comprising a non-transitory computer readable medium having program instructions that when executed by a processor of an electronic device comprising a first display and a first image capturing device (ICD), configure the electronic device to perform functions comprising:
detecting an activation of a mirror mode of the electronic device;
capturing image data from the first image capturing device;
rendering and presenting the captured image data on the first display;
detecting a human face in the captured image data; and
in response to detecting a hand movement proximal to a first region of the detected human face, activating a grooming mode operation comprising autonomously changing an image capturing characteristic of the first ICD to more clearly present the first region of the face, which is presented on the first display.
